(19) United States
(12) Patent Application Publication
(10) Pub. No.: US 2009/0287038 A1
(43) Pub. Date: Nov. 19, 2009

(54) IMPLANTED-TRANSDUCER BONE CONDUCTION DEVICE

(75) Inventor: John L. Parker, Roseville (AU)

Correspondence Address: CONNOLLY BOVE LODGE & HUTZ LLP, 1875 EYE STREET, N.W., SUITE 1100, WASHINGTON, DC, 20006, US

(73) Assignee: COCHLEAR LIMITED, Lane Cove (AU)

(21) Appl. No.: 12/353,714

(22) Filed: Jan. 14, 2009

Related U.S. Application Data
(60) Provisional application No. 61/041,185, filed on Mar. 31, 2008.

(51) Int. Cl. H04R 25/00

(52) U.S. Cl. 600/25

(57) ABSTRACT

An implanted-transducer bone conduction device for enhancing the hearing of a recipient, comprising: a sound input element configured to receive an acoustic sound signal; an electronics module configured generate an electrical signal representing said acoustic sound signal; a transducer implanted within the recipient and mechanically coupled to the recipient's bone, said implanted transducer configured to generate mechanical forces representing said electrical signal for deliver to the recipient's skull.

### CROSS-REFERENCE TO RELATED APPLICATIONS

The present application claims the benefit of U.S. Provisional Patent Application 61/041,185; filed Mar. 31, 2008, which is hereby incorporated by reference herein.

### BACKGROUND

1. Field of the Invention

The present invention is generally directed to an implanted-transducer bone conduction device, and more particularly, to an implanted-transducer bone conduction device.

2. Related Art

Hearing loss, which may be due to many different causes, is generally of two types, conductive or sensorineural. In many people who are profoundly deaf, the reason for their deafness is sensorineural hearing loss. This type of hearing loss is due to absence, destruction, or damage to the hairs that transduce acoustic signals into nerve impulses in the cochlea. Various prosthetic hearing implants have been developed to provide individuals who suffer from sensorineural hearing loss with the ability to perceive sound. One type of prosthetic implant, referred to as a cochlear implant, uses an electrode array implanted in the cochlea. More specifically, an electrical stimulus is provided via the electrode array directly to the cochlea nerve, thereby inducing a hearing sensation in the implant recipient.

Conductive hearing loss occurs when the normal mechanical pathways, which conduct sound to hairs in the cochlea, are impeded. This problem may arise from damage to the ossicular chain to ear canal. However, individuals who suffer from conductive hearing loss frequently still have some form of residual hearing because the hairs in the cochlea are often undamaged. For this reason, individuals who suffer from conductive hearing loss are typically not candidates for a cochlear implant, because insertion of the electrode array into a cochlea may result in the severe damage or destruction of the most of the hair cells within the cochlea.

Sufferers of conductive hearing loss typically receive an acoustic hearing aid. Hearing aids receive ambient sound in the outer ear, amplify the sound, and direct the amplified sound into the ear canal. The amplified sound reaches the cochlea and causes motion of the cochlea fluid, thereby stimulating the hairs in the cochlea.

An alternative to a normal air conduction aid is a bone conduction hearing aid which incorporates a hearing aid which drives a vibrator which is pushed against the skull via a mechanism. Such mechanisms include glasses and wire hoops. These devices are uncomfortable to wear and for some recipients are incapable of producing sufficient gain.

Unfortunately, hearing aids do not benefit all individuals who suffer from conductive hearing loss. For example, some individuals are prone to chronic inflammation or infection of the ear canal and cannot wear hearing aids. Other individuals have malformed or absent outer ear and/or ear canals as a result of a birth defect, or as a result of common medical conditions such as Treacher Collins syndrome or Microtia. Hearing aids are also typically unsuitable for individuals who suffer from single-sided deafness (i.e., total hearing loss only in one ear) or individuals who suffer from mixed hearing losses (i.e., combinations of sensorineural and conductive hearing loss).

Those individuals who cannot benefit from hearing aids may benefit from hearing prostheses that are implanted into the skull bone. Such hearing prostheses direct vibrations into the bone, so that the vibrations are conducted into the cochlea and result in stimulation of the hairs in the cochlea. This type of prosthesis is typically referred to as an implanted-transducer bone conduction device.

Implanted-transducer bone conduction devices function by converting a received sound into a mechanical vibration representative of the received sound. This vibration is then transferred to the bone structure of the skull, causing vibration of the recipient's skull and serves to stimulate the cochlea hairs, thereby inducing a hearing sensation in the recipient.

### SUMMARY

According to one aspect of the present invention, there is provided an implanted-transducer bone conduction device for enhancing the hearing of a recipient, comprising: a sound input element configured to receive an acoustic sound signal; an electronics module configured generate an electrical signal representing said acoustic sound signal; a transducer implanted within the recipient and mechanically coupled to the recipient's bone, said implanted transducer configured to generate mechanical forces representing said electrical signal for deliver to the recipient's skull.

According to another aspect of the present invention, there is provided an method for rehabilitating the hearing of a recipient with an implanted-transducer bone conduction device having at least one or more transducer implanted within the recipient so as to form a mechanical coupling between said implanted transducer and the recipient's bone, comprising: receiving an electrical signal representative of an acoustic sound signal; generating, via said implanted transducer, mechanical forces representative of the received electrical signal; and delivering said mechanical forces to the recipient's skull via the mechanical coupling.

### BRIEF DESCRIPTION OF THE DRAWINGS

Illustrative embodiments of the present invention are described herein with reference to the accompanying drawings, in which:

FIG. 1 is a perspective view of an implanted-transducer bone conduction device provided to a recipient according to one embodiment of the present invention;

FIG. 2A is a high-level functional block diagram of an implanted-transducer bone conduction device according to one embodiment of the present invention, such as the device of FIG. 1;

FIG. 2B is a detailed functional block diagram of the implanted-transducer bone conduction device illustrated in FIG. 2A;

FIG. 3 is a flowchart illustrating the conversion of an input sound into skull vibration in an implanted-transducer bone conduction device according to one embodiment of the present invention;

FIG. 4 is a perspective view of an implanted-transducer bone conduction device according to a further embodiment of the present invention;

FIG. 5 is a perspective view of an implanted-transducer bone conduction device according to a yet further embodiment of the present invention;

FIG. 6 is a perspective view of an implanted-transducer bone conduction device according to another embodiment of the present invention;

FIG. 7 is a perspective side view of an implanted-transducer bone conduction device according to yet another embodiment of the present invention;

FIG. 8A is a perspective side view of an implanted-transducer bone conduction device according to another embodiment of the present invention;

FIG. 8B is a perspective side view of the device shown in FIG. 8A;

FIG. 8C is a perspective side view of the device of FIG. 8A;

FIG. 8D is an isometric view of the device shown in FIG. 8A; and

FIG. 9 is a perspective side view of an implanted-transducer bone conduction device according to a further embodiment of the present invention.

### DETAILED DESCRIPTION

Embodiments of the present invention are generally directed to an implanted-transducer bone conduction device for converting a received acoustic sound signal into a stimulation control signal, communicating that stimulation control signal to an implanted actuator that is in contact with the recipient's bone, generating a mechanical force configured to cause the recipient to perceived the received acoustic sound signal when the mechanical force is delivered via the recipient's bone to the recipient's hearing organs, and delivering that mechanical force to the recipient. The implanted-transducer bone conduction device includes a sound input component, such as microphone, to receive the acoustic sound signal, an electronics module configured to generate an electrical signal representing the acoustic sound signal, and a piezoelectric transducer to convert the electrical signal into a mechanical force for delivery to the recipient's skull. In certain embodiments of the present invention, the transducer is connected to one or several magnets or metal components which are magnetically coupled to magnets implanted between the recipient's bone and skin. In other embodiments of the present invention, one or several metal components, which are connected to the transducer, are magnetically coupled to corresponding magnets that are implanted between the recipient's bone and skin. The magnets or metal components connected to the transducer are connected such that force generated by the transducer is mechanically communicated to the connected magnets or metal components, which in turn magnetically communicate the generate force or portions thereof to the implanted one or several magnets or metal components. The piezoelectric transducer has a piezoelectric element that deforms in response to application of the electrical signal thereto. The transducer has an output stroke that exceeds the deformation of the piezoelectric element.

The output stroke of the transducer (sometimes referred to herein as the “transducer stroke”) is utilized to generate a mechanical force that may be provided to the recipient's skull. The sound perceived by a recipient is dependent, in part, upon the magnitude of mechanical force generated by the transducer. In some implanted-transducer bone conduction devices, the magnitude of the mechanical force may be limited by the available transducer stroke. These limitations may cause distortion in the sound signal perceived by the recipient or limit the population of recipient's that may benefit from the device. For example, in certain embodiments, limited transducer stroke results in insufficient gain to adequately represent a received acoustic sound signal for all individuals. This insufficient gain may cause a signal to be clipped or otherwise distorted.

As noted, the piezoelectric transducer comprises a piezoelectric element. The piezoelectric element converts an electrical signal applied thereto into a mechanical deformation (i.e. expansion or contraction) of the element. The amount of deformation of a piezoelectric element in response to an applied electrical signal depends on material properties of the element, orientation of the electric field with respect to the polarization direction of the element, geometry of the element, etc.

The deformation of the piezoelectric element may also be characterized by the free stroke and blocked force of the element. The free stroke of a piezoelectric element refers to the magnitude of deformation induced in the element when a given voltage is applied thereto. Blocked force refers to the force that must be applied to the piezoelectric element to stop all deformation at the given voltage. Generally speaking, piezoelectric elements have a high blocked force, but a low free stroke. In other words, when a voltage is applied to the element, the element will can output a high force, but will only a small stroke.

As noted, implanted-transducer bone conduction devices generate a mechanical force that is delivered to the skull, thereby causing motion of the cochlea fluid and a hearing perception by the recipient. In some piezoelectric transducers, the maximum available transducer stroke is equivalent to the free stroke of the piezoelectric element. As such, some implanted-transducer bone conduction devices utilizing these types of piezoelectric transducer have a limited transducer stroke and corresponding limits on the magnitude of the mechanical force that may be provided to the skull.

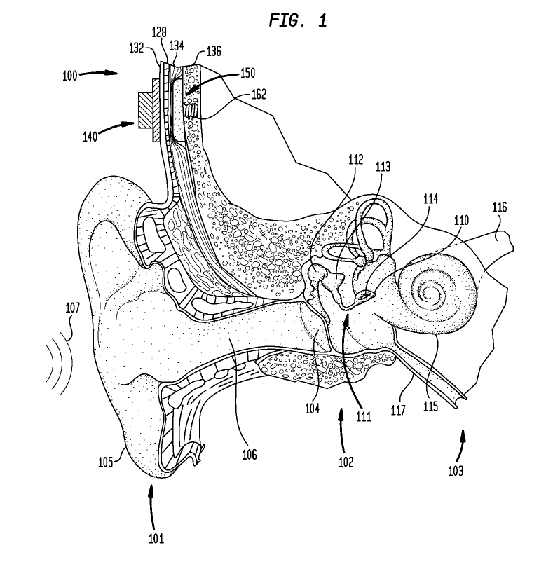

FIG. 1 is a perspective view of embodiments of an implanted-transducer bone conduction device 100 in which embodiments of the present invention may be advantageously implemented. In a fully functional human hearing anatomy, outer ear 105 comprises an auricle 105 and an ear canal 106. A sound wave or acoustic pressure 107 is collected by auricle 105 and channeled into and through ear canal 106. Disposed across the distal end of ear canal 106 is a tympanic membrane 104 which vibrates in response to acoustic wave 107. Eustachian tube 117 is closed on the end away from tympanic membrane 104, creating a closed air pocket within Eustachian tube 117. This vibration is coupled to oval window or fenestra ovalis 110 through three bones of middle ear 102, collectively referred to as the ossicles 111 and comprising the malleus 112, the incus 113 and the stapes 114. Bones 112, 113 and 114 of middle ear 102 serve to filter and amplify acoustic wave 107, causing oval window 110 to articulate, or vibrate. Such vibration sets up waves of fluid motion within cochlea 115. Such fluid motion, in turn, activates tiny hair cells (not shown) that line the inside of cochlea 115. Activation of the hair cells causes appropriate nerve impulses to be transferred through the spiral ganglion cells and auditory nerve 116 to the brain (not shown), where they are perceived as sound.

FIG. 1 also illustrates the positioning of implanted-transducer bone conduction device 100 relative to outer ear 101, middle ear 102 and inner ear 103 of a recipient of device 100. As shown, one or more components of implanted-transducer bone conduction device 100 may be positioned behind outer ear 101 of the recipient, and other components of implanted-transducer bone conduction device 100 may be implanted in the recipient. It is to be understood that the position of implanted-transducer bone conduction device 100 is merely exemplary, and that the other positions in other embodiments of the present invention are considered a part of the present invention.

In the embodiments illustrated in FIG. 1, implanted-transducer bone conduction device 100 comprises external component 140 and implanted component 150. External component 140 does not generate stimulation mechanical force, while implanted component 150 is configured to generate stimulation mechanical force that is conducted via one or more recipient's bone to produce an auditory stimulation. As described below, external component 140 may comprise a sound processor and signal transmitter, while implanted component 150 may comprise a transducer, transducer drive components, a signal receiver and/or various other electronic circuits/devices.

In accordance with embodiments of the present invention, an anchor system 162 may be used to hold the implanted transducer module 208 in place in the recipient. As described below, anchor system 162 may be fixed to bone 136 and also attached to the implanted component of the present invention. In various embodiments, anchor system 162 may be implanted under skin 132 within muscle 134 and/or fat 128. In certain embodiments, a coupling 140 attaches device 100 to anchor system 162.

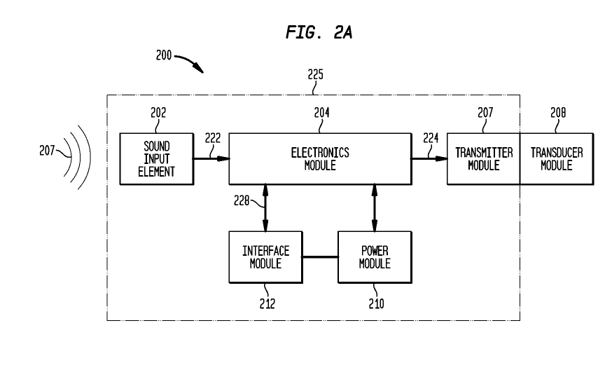

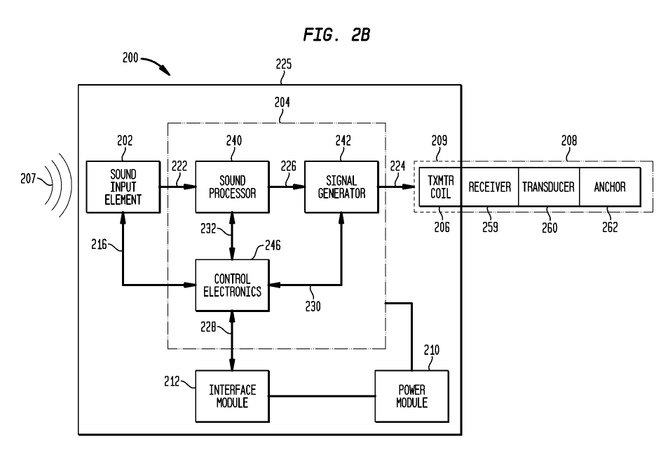

A high-level functional block diagram of one embodiment of implanted-transducer bone conduction device 100, referred to as implanted-transducer bone conduction device 200, is shown in FIG. 2A. In the illustrated embodiment, a sound 207 is received by a sound input element 202. In some embodiments, sound input element 202 is a microphone configured to receive sound 207, and to convert sound 207 into an electrical signal 222. As described below, in other embodiments sound 207 may be received by sound input element 202 already as an electrical signal 222 and not converted by sound input element 202.

As shown in FIG. 2A, electrical signal 222 is output by sound input element 202 to an electronics module 204. Electronics module 204 is configured to convert electrical signal 222 into an adjusted electrical signal 224. As described below in more detail, electronics module 204 may include a sound processor, control electronics, and a variety of other elements.

As shown in FIG. 2A, transmitter module 209 receives adjusted electrical signal 224 and processes it for transmission to the implanted components, including to transducer module 208. The implanted components receives the transmitted adjusted electrical signal 224 from transmitter module 209 and provides it to transducer module 208, which generates a mechanical output force that is delivered to the skull. The transducer module includes a coupling or anchor (not shown) which mechanically couples transducer module 208 to the recipient's bone, such that the vibrations generated by the transducer is communicated to the recipient's bone through that coupling or anchor. The vibration caused to the recipient's skull may be one or multi-directional from the coupling or anchor, depending on the configuration of the transducer and the vibration that it is configured to generate.

FIG. 2A also illustrates a power module 210. Power module 210 provides electrical power to one or more components of implanted-transducer bone conduction device 200. For ease of illustration, power module 210 has been shown connected only to interface module 212 and electronics module 204. However, it should be appreciated that power module 210 may be used to supply power to any electrically powered circuits/components of implanted-transducer bone conduction device 200.

Implanted-transducer bone conduction device 200 further includes an interface module 212 that allows the recipient to interact with device 200. For example, interface module 212 may allow the recipient to adjust the volume, alter the speech processing strategies, power on/off the device, etc. Interface module 212 communicates with electronics module 204 via signal line 228.

In the embodiment illustrated in FIG. 2A, sound pickup element 202, electronics module 204, transmitter module 209, power module 210 and interface module 212 have all been shown as integrated in a single housing, referred to as housing 225. However, it should be appreciated that in certain embodiments of the present invention, one or more of the illustrated components may be housed in separate or different housings. Similarly, it should also be appreciated that in such embodiments, direct connections between the various modules and devices are not necessary and that the components may communicate, for example, via wireless connections.

FIG. 2B provides a more detailed view of implanted-transducer bone conduction device 200 of FIG. 2A. In the illustrated embodiment, electronics module 204 comprises a sound processor 240, signal generator 242 and control electronics 246. As explained above, in certain embodiments sound input element 202 comprises a microphone configured to convert a received acoustic signal into electrical signal 222.

In embodiments of the present invention, electrical signal 222 is output from sound input element 202 to sound processor 240. Sound processor 240 uses one or more of a plurality of techniques to selectively process, amplify and/or filter electrical signal 222 to generate a processed signal 226. In certain embodiments, sound processor 240 may comprise substantially the same sound processor as is used in an air conduction hearing aid. In further embodiments, sound processor 240 comprises a digital signal processor.

Processed signal 226 is provided to signal generator 242. Signal generator 242 outputs a transducer control signal 224 to transmitter module 209 which comprises a transmission means such as a transmitter coil 206. Transmitter coils for hearing prostheses communication will be known to one having ordinary skill in the art. Transducer control signal 224 is transmitted via transmitter coil 206 of transmitter module 209 to a receiver coil (not shown) of receiver module 259 of transducer module 208. Transducer 260 of transducer module 208 generates mechanical vibration that is communicated through the recipient's bone in order to provide stimulation to the auditory nerve of the recipient.

For ease of description the signal supplied by signal generator 242 via transmitter module 209 to transducer module 208 has been referred to as transducer control signal 224. However, it should be appreciated that control signal 224 may comprise an unmodified version of processed signal 226, which may be further processed in implanted component 208 in other embodiments of the present invention.

In embodiments of the present invention, transducer module 208 may be one of many types and configurations of transducers, now known or later developed. In one embodiment of the present invention, transducer module 208 may comprise a piezoelectric element which is configured to deform in response to the application of electrical signal 224. Piezoelectric elements that may be used in embodiments of the present invention may comprise, for example, piezoelectric crystals, piezoelectric ceramics, or some other material exhibiting a deformation in response to an applied electrical signal. Exemplary piezoelectric crystals include quartz (SiO2), Berlinite (AlPO4), Gallium orthophosphate (GaPO4) and Tourmaline. Exemplary piezoelectric ceramics include barium titanate (BaTiO30), lead zirconium titanate (PZT), or zirconium (Zr).

Some piezoelectric materials, such as lead zirconium titanate and PZT, are polarized materials. When an electric field is applied across these materials, the polarized molecules align themselves with the electric field, resulting in induced dipoles within the molecular or crystal structure of the material. This alignment of molecules causes the deformation of the material.

In other embodiments of the present invention, other types of transducers may be used. For example, various motors configured to operate in response to electrical signal 224 may be used.

In one embodiment of the present invention, transducer module 208 generates an output force that causes movement of the cochlea fluid so that a sound may be perceived by the recipient. The output force may result in mechanical vibration of the recipient's skull, or in physical movement of the skull about the neck of the recipient. As noted above, in certain embodiments, implanted-transducer bone conduction device 300 delivers the output force to the skull of the recipient via direct contact of transducer 260 with the recipient's bone. In other embodiments of the present invention, transducer 260 may be housed within a housing (not shown) that is mechanically coupled to transducer 260 and also implanted within and in direct contact with the recipient's bone. As such, vibration forces generated by transducer 260 in that housing will be communicated through said housing to the recipient's bone and ultimately to the recipient's cochlea.

In certain embodiments of the present invention, electronics module 204 includes a printed circuit board (PCB) to electrically connect and mechanically support the components of electronics module 204. Sound input element 202 may comprise one or more microphones (not shown) and is attached to the PCB.

As noted above, a recipient may control various functions of the device via interface module 212. Interface module 212 includes one or more components that allow the recipient to provide inputs to, or receive information from, elements of implanted-transducer bone conduction device 200.

In embodiments of the present invention, based on inputs received at interface module 212, control electronics 246 may provide instructions to, or request information from, other components of implanted-transducer bone conduction device 200. In certain embodiments, in the absence of user inputs, control electronics 246 control the operation of implanted-transducer bone conduction device 200.

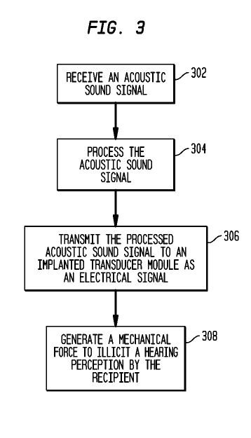

FIG. 3 illustrates the conversion of an input acoustic sound signal into a mechanical force for delivery to the recipient's skull in accordance with embodiments of implanted-transducer bone conduction device 200. At block 302, an acoustic sound signal 107 is received by the device of the present invention. In certain embodiments, the acoustic sound signal is received via microphones. In other embodiments, the input sound is received via an electrical input. In still other embodiments, a telecoil integrated in, or connected to, implanted-transducer bone conduction device 200 may be used to receive the acoustic sound signal.

At block 304, the acoustic sound signal received by implanted-transducer bone conduction device 200 is processed by the speech processor in electronics module 204. As explained above, the speech processor may be similar to speech processors used in acoustic hearing aids. In such embodiments, speech processor may selectively amplify, filter and/or modify acoustic sound signal. For example, speech processor may be used to eliminate background or other unwanted noise signals received by implanted-transducer bone conduction device 200.

At block 306, the processed sound signal is provided to implanted transducer module 208 as an electrical signal. At block 308, transducer module 208 converts the electrical signal into a mechanical force configured to be delivered to the recipient's skull so as to illicit a hearing perception of the acoustic sound signal. As transducer module 208, in certain embodiments of the present invention, is implanted and also has a transducer therewithin, the vibration generated by transducer module 208 is communicated to the recipient's cochlea or the recipient's auditory nerve.

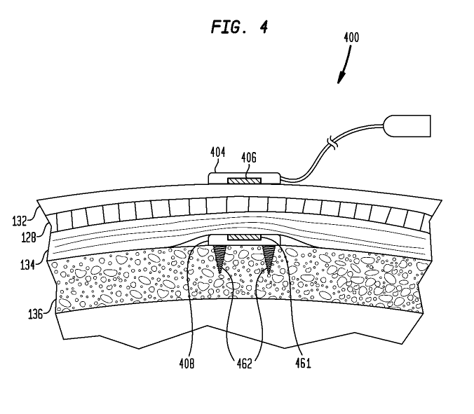

FIG. 4 illustrates one embodiment of the present invention in which implanted-transducer bone conduction device 500 is implanted beneath the various tissue layers shown, and is contact the outer surface of the recipient's skull. Device 500 is implanted beneath one or more tissue layers and brought into substantial contact with the recipient's bone 136 such that vibration forces from the implanted transducer module 408 is communicated from module 408 to the recipient's bone 136. As one having ordinary skill will appreciate, there may be one or more thin tissue layers between transducer module 408 and the recipient's bone while still permitting sufficient support so as to allow efficient communication of the vibration forces generated by transducer module 408 to recipient's bone 136. As shown, one or more anchors 462 may be used to secure implanted transducer module 408 against recipient bone 136. Even where one or more thin tissue layers are disposed between transducer module 408 and bone 136, one or more anchors 462 act to securely hold transducer module 408 against bone 136 such that vibration from transducer module 408 is efficiently communicated to bone 136. Also, anchors 462 hold transducer module 408 securely so as to prevent translational movement of transducer module 408 with respect to the surface of recipient bone 136 after implantation. It is to be understood that other embodiments of the present invention may have only one anchor, instead of the two anchors 462 shown in FIG. 4. Similarly, in yet other embodiments of the present invention, more than two anchors 462 may be used to secure implanted transducer 408 in place.

In the embodiment of the present invention illustrated in FIG. 4, anchors 408 are formed as a screw that is positioned within recipient's bone 136. In other embodiments of the present invention, anchor 408 may be a textured rod that is constructed and arranged to integrate with the adjacent tissue or bone over time. In yet further embodiments of the present invention, anchors 462 may instead be a mesh that is coupled to implanted transducer 408, where the mesh is constructed and arranged to integrate with the surrounding tissue or bone over time so as to secure transducer 408 in place after integration.

In the embodiment illustrated in FIG. 4, transmitter coil 406 of external electronics module 404 transmits stimulation control signals via implanted receiver coil 461 to implanted transducer module 408. Transducer module 408 then generates stimulation-inducing mechanical vibration for communication via the recipient's bone 136 to the auditory nerve or to the recipient's cochlear. For the sake of simplicity, other components of device 400 are shown in FIG. 4 but not described here as they are described elsewhere or will be apparent to those having skill in the relevant art.

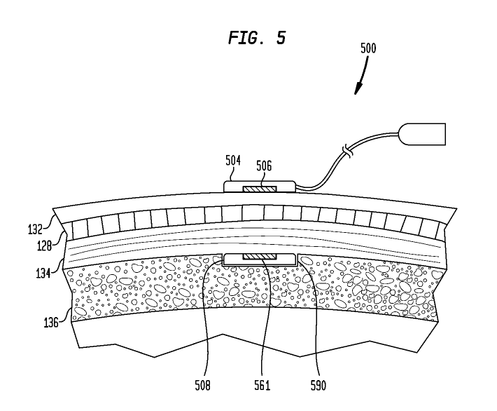

FIG. 5 depicts a further embodiment of the present invention that is similar to the embodiment illustrated in FIG. 4. Instead of anchors 462, the embodiment illustrated in FIG. 5 is secured within a bone that is surgically formed in the recipient's bone. In further embodiments of the present invention, a small or significant portion of bone bed 590 may be sized so as to allow a compression fit of implanted transducer module 508 in bone bed 590 so as to secure the module 508 initially or even after an extended period of time. Implanted transducer module 508 may thus be secured in the recipient's bone so as to prevent translational movement with respect to the surface of recipient's bone 136. In other embodiments of the present invention, implanted transducer module 508 is positioned within a formed bed 590 in the recipient's bone so as to reduce or minimize the extent to which transducer module 508 rests above the outer surface of the recipient's bone, thereby reducing the protrusion height or associated interaction between the recipient's tissue and the outer surface of transducer module 508. Even though positioned within bone bed 590 which may provide some or significant anti-translation benefits, transducer module 508 may be further secured within the bone bed by means of screws, mesh, adhesives, sutures, staples, and other fixation means.

In FIG. 6, another embodiment of the present invention is illustrated in which implanted transducer module 608 is positioned within a bone bed 690 that is formed on the inner surface of recipient's bone 136. In the embodiment illustrated, the availability of suitable space in a cavity within the recipient, and/or ease of access and protection from external forces and elements, may make this inward-facing implantation of such devices desirable. In these embodiments of the present invention, transmitter module 604 may be positioned further from other embodiments of the present invention in which the receiver module 608 is disposed on the outer surface of recipient's bone 136. The mechanism for communicating control signals from transmitter coil 606 to the receiver coil (not shown) for receiver module 608 may be of a different kind or strength than the mechanism used for other embodiments of the present invention in which the implanted transducer module is closer to the external electronics module 604.

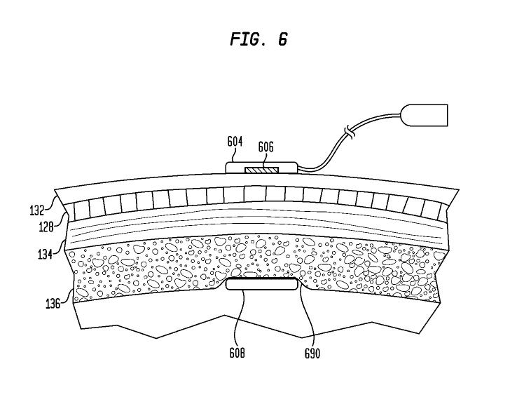

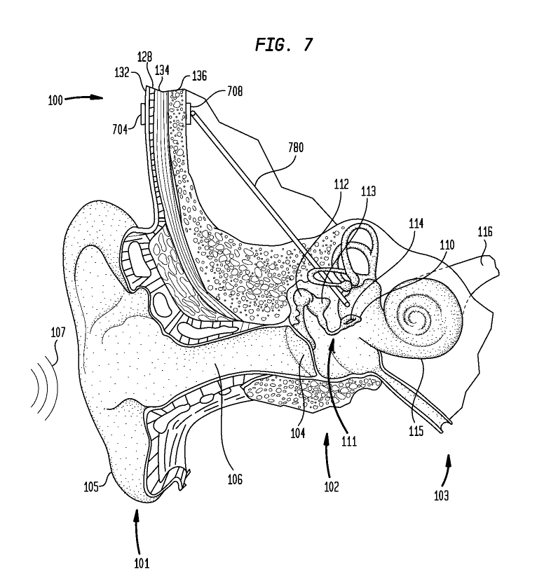

In FIG. 7, another embodiment of the present invention is shown in which a communication arm 780 is mechanically coupled to implanted transducer module 708 so as to transmit the mechanical vibration generated by transducer module 708 through communication arm 780 to one or more anatomy in the recipient that will in turn produce auditory stimulation for the recipient. For example, in the exemplary embodiment illustrated, communication arm 780 is shown, in simplified form, as extending to the recipient's mastoid. By communicating the vibration from transducer module 708 to the recipient's mastoid, the cochlea can be vibrated and the fluids contained therein moved so as to cause hearing sensation in the auditory nerve. In embodiments of the present invention employing communication arm 780, implanted transducer module 708 may be secured indirectly to the recipient's bone, or not to bone at all, such that vibration from transducer module 708 are not also communicated to the recipient's bone such that interfering vibration or other stimulation does not get generated or communicated. For example, in one such embodiment, transducer module 708 may be secured to soft tissue which will not allow substantial vibration to be communicated to the recipient's cochlea. Communication arm 780 may comprise more than a single arm, and may also comprise mechanical joints (not shown) which may or may not be adjustable at the time of the surgery.

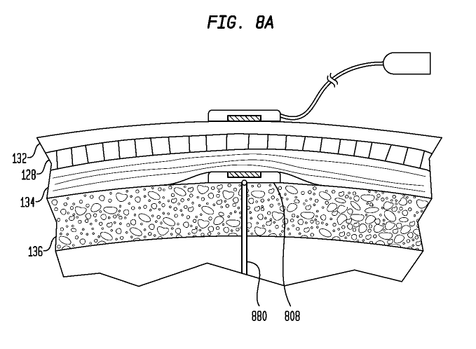

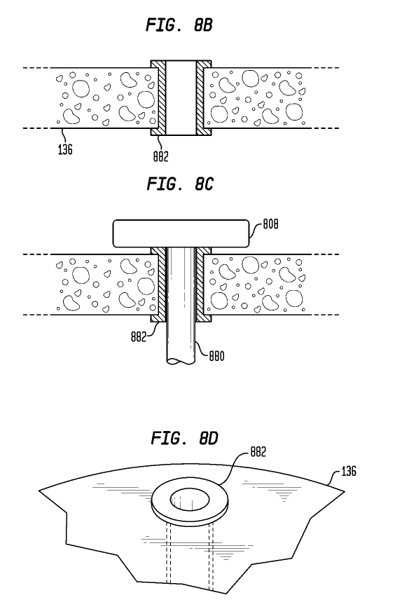

FIGS. 8A through 8D illustrates another embodiment of the present invention in which communication arm 880 is mechanically coupled to implanted transducer module 808, similar to the embodiment described with respect to FIG. 7. However, in the particular embodiment illustrated in FIGS. 8A through 8D, implanted transducer module 808 is secured to the recipient's bone on the outer surface of the recipient's bone 136. As illustrated in FIGS. 8B through 8D, access component 882 has a lumen extending therethrough which allowed communication arm 880 to reach transducer module 808 so as to receive the vibration forces generated by transducer module 808. but not anchor system 208 comprises a single external magnet 408. In certain embodiments of this particular embodiment of the present invention, access component 882 may be constructed of a resiliently flexible biocompatible material such as silicone, in order to allow proper movement of communication arm 880 within access component 882 while also providing sufficient seal in order to maintain various body fluids on one side of recipient bone 136 while preventing entry of particulates and other matter from the other side of bone 136. In other embodiments of the present invention, where the situation and nature of the location permits, access component 882 may be configured such that the diameter of the lumen extending therethrough is greater than the diameter of the portion of communication arm 880 positioned therein, such that the vibration or mechanical forces generated by implanted transducer module 808 and communicated by communication arm 880 is less dampened or otherwise reduced or misdirected than if the fit between that portion of communication arm 880 and access component 882 were might tight.

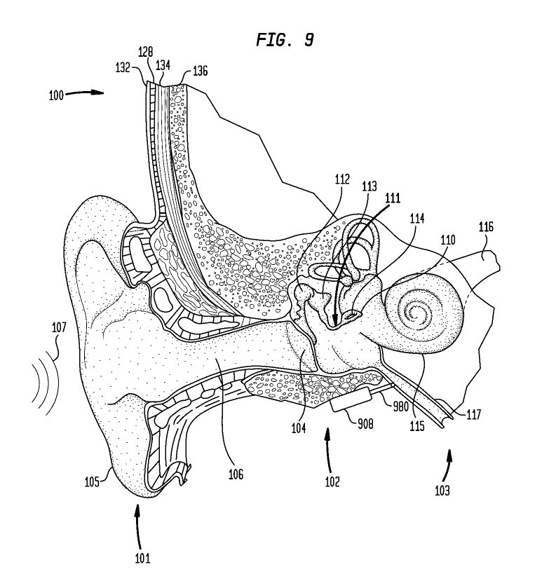

In the embodiment illustrated in FIG. 9, implanted transducer module 908 is coupled to communication arm 980, which is in turn coupled to eustachian tube 117. The embodiment of FIG. 9 is illustrative of the fact that implanted transducer module 908 may be positioned in other area's of the recipient's anatomy in such a manner as to effect a movement of the cochlear fluids, the hair in the cochlea, or other stimulation of the auditory nerve 116. In the embodiment of the present invention illustrated in FIG. 9, communication arm 980 is coupled to eustachian tube 117 such that vibration forces generated by transducer module 908 is communicated to the walls of eustachian tube 117 such that the closed air pocket therein is compressed or expanded, as the vibration through communication arm 980 causes eustachian tube 117 to rapidly deform. The compression or expansion of the closed air pocket within eustachian tube 117 in turn may cause movement of the various bones or tissue directly or indirectly in contact with the cochlea, causing the fluids therein to be moved. It is to be understood that the position and dimensions of implanted transducer 908 are greatly simplified or not drawn to proper scale or configuration, and that the various parts of the present invention depicted therein are for illustrative purposes only.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents. All patents and publications discussed herein are incorporated in their entirety by reference thereto.

What is claimed is:

1. An implanted-transducer bone conduction device for enhancing the hearing of a recipient, comprising:
a sound input element configured to receive an acoustic sound signal;
an electronics module configured generate an electrical signal representing said acoustic sound signal;
a transducer implanted within the recipient and mechanically coupled to the recipient's bone, said implanted transducer configured to generate mechanical forces representing said electrical signal for deliver to the recipient's skull.

2. The device of claim 1, further comprising one or more anchors configured to secured said implanted transducer to the recipient's bone.

3. The device of claim 1, further comprising a communication arm configured to deliver said mechanical forces from said implanted transducer to a bone portion of the recipient remote from said transducer.

4. The device of claim 1, wherein said transducer is disposed within a biocompatible housing.

5. The device of claim 4, wherein said biocompatible housing is configured to be positioned within a bone bed formed on a surface of the recipient's bone.

6. The device of claim 2, wherein said one or more anchors comprises at least one screw-shaped anchor.

7. The device of claim 2, wherein said one or more anchors comprises at least one mesh coupled to said implanted transducer and configured to integrate with the recipient's tissue.

8. The device of claim 2, wherein said one or more anchors comprises at least one suture configured to secure at least a portion of said implanted transducer to the recipient's bone.

9. The device of claim 2, wherein said one or more anchors comprises an adhesive configured to secure said implanted transducer to the recipient's bone.

10. The device of claim 1, wherein said implanted transducer is secured to the inner surface of the recipient's bone on the side opposite the outer bone surface.

11. The device of claim 2, further comprising an access component comprising a lumen extending therethrough, wherein said access component is positioned within a hole formed in the recipient's bone, and further wherein said lumen is configured to have disposed therein at least a portion of said communication arm.

12. The device of claim 11, wherein the lumen of said access component has a diameter that is larger than the diameter of said communication arm portion extending therethrough.

13. The device of claim 11, wherein said access component has sealing flanges extending circumferentially around said access component and configured to seal the recipient's bone where said access component extends therethrough.

14. The device of claim 3, wherein said communication arm is configured to be mechanically coupled to the recipient's mastoid such that said mechanical forces are communicated via said communication arm to said recipient's mastoid.

15. The device of claim 3, wherein said communication arm is configured to be mechanically coupled to the recipient's eustachian tube such that said mechanical forces are communicated via said communication arm to said recipient's eustachian tube.

16. A method for rehabilitating the hearing of a recipient with an implanted-transducer bone conduction device having at least one or more transducer implanted within the recipient so as to form a mechanical coupling between said implanted transducer and the recipient's bone, comprising:
receiving an electrical signal representative of an acoustic sound signal;
generating, via said implanted transducer, mechanical forces representative of the received electrical signal; and
delivering said mechanical forces to the recipient's skull via the mechanical coupling.

17. The method of claim 16, wherein the mechanical coupling is formed using a communication arm between said implanted transducer and a recipient bone remote from said implanted transducer.
